(19) United States
(12) Patent Application Publication
(10) Pub. No.: US 2026/0087422 A1
(43) Pub. Date: Mar. 26, 2026

(54) METHOD AND SYSTEM FOR FITTING 2-DIMENSIONAL (2D) PART DRAWINGS IN 2D SHEET DRAWINGS

(71) Applicant: HCL Technologies Limited, New Delhi (IN)

(72) Inventor: Yash Kumar Dungerpuria, Navi Mumbai (IN)

(21) Appl. No.: 19/086,220

(22) Filed: Mar. 21, 2025

(30) Foreign Application Priority Data
Sep. 25, 2024 (IN) 202411072579

(51) Int. Cl. G06Q 10/04

(52) U.S. Cl. CPC G06Q 10/043

(57) ABSTRACT

This disclosure relates to method and system for fitting 2-dimensional (2D) part drawings in 2D sheet drawings. The method includes receiving a first part drawing corresponding to a first 2D part and a sheet drawing corresponding to a 2D sheet. The 2D sheet includes a plurality of corners. The method further includes identifying a plurality of valid positions for the first part drawing on the sheet drawing based on the plurality of corners and a plurality of predefined nesting directions. The method further includes, at each of the plurality of valid positions, evaluating each of a plurality of orientations of the first part drawing on the sheet drawing based on predefined selection criteria. The method further includes determining an optimal orientation from the plurality of orientations and an optimal position from the plurality of valid positions in order to optimize a packing efficiency function.

### TECHNICAL FIELD

This disclosure relates generally to 2-Dimensional (2D) nesting, and more particularly to method and system for fitting 2D part drawings in 2D sheet drawings.

### BACKGROUND

Manufacturing industries are responsible for manufacturing of different 3-dimensional (3D) and 2-dimensional (2D) objects. While manufacturing 2D objects, shapes of 2D parts are placed on a larger 2D sheets of raw material by the process of nesting. Nesting is a process of placing smaller 2D shapes in a larger 2D shape using packing algorithms such that minimum area of the larger 2D shape (and hence minimum raw material) is wasted. The 2D sheets could be made of wood, metal, leather, textile, paper, glass, etc. It is desired by the manufacturing industries that the raw material usage is minimized. The packing algorithms used should be optimal to ultimately reduce raw material consumption.

However, nesting problems encountered in manufacturing industries include fitting multiple quantities (or copies) of a single geometric shape (i.e., single 2D part) or multiple copies of multiple geometric shapes (i.e., multiple 2D parts) on the raw material. Conventional fitting techniques used in a nesting operation search for locations to place the 2D part drawings on the 2D sheet from a single predefined corner of the 2D sheet and in a single direction from the predefined corner. However, this may not be optimal for fitting each 2D part drawing in the 2D sheet. These techniques compute possible positions of the 2D part drawing from just one corner of the 2D sheet and one direction every time, which is a limiting approach.

### SUMMARY

In one embodiment, a method for fitting 2-dimensional (2D) part drawings in 2D sheet drawings is disclosed. In one example, the method may include receiving a first part drawing corresponding to a first 2D part and a sheet drawing corresponding to a 2D sheet. The 2D sheet may include a plurality of corners. The method may further include identifying a plurality of valid positions for the first part drawing on the sheet drawing using predefined criteria based on the plurality of corners and a plurality of predefined nesting directions. At each of the plurality of valid positions, the method may further include, evaluating each of a plurality of orientations of the first part drawing on the sheet drawing based on predefined selection criteria. The method further includes determining an optimal orientation from the plurality of orientations and an optimal position from the plurality of valid positions in order to optimize the packing efficiency function.

In another embodiment, a system for fitting 2D part drawings in 2D sheet drawings is disclosed. In one example, the system may include a processor and a computer-readable medium communicatively coupled to the processor. The computer-readable medium may store processor-executable instructions, which, on execution, may cause the processor to receive a first part drawing corresponding to a first 2D part and a sheet drawing corresponding to a 2D sheet. The 2D sheet may include a plurality of corners. The processor-executable instructions, on execution, may further cause the processor to identify a plurality of valid positions for the first part drawing on the sheet drawing using predefined criteria based on the plurality of corners and a plurality of predefined nesting directions. At each of the plurality of valid positions, the processor-executable instructions, on execution, may further cause the processor to evaluate each of a plurality of orientations of the first part drawing on the sheet drawing based on predefined selection criteria. The processor-executable instructions, on execution, may further cause the processor to determine an optimal orientation from the plurality of orientations and an optimal position from the plurality of valid positions in order to optimize the packing efficiency function.

In one embodiment, a non-transitory computer-readable medium storing computer-executable instructions for fitting 2D part drawings in 2D sheet drawings. In one example, the stored instructions, when executed by a processor, may cause the processor to perform operations including receiving a first part drawing corresponding to a first 2D part and a sheet drawing corresponding to a 2D sheet. The 2D sheet may include a plurality of corners. The operations may further include identifying a plurality of valid positions for the first part drawing on the sheet drawing using predefined criteria based on the plurality of corners and a plurality of predefined nesting directions. At each of the plurality of valid positions, the operations may further include evaluating each of a plurality of orientations of the first part drawing on the sheet drawing based on predefined selection criteria. The operations may further include determining an optimal orientation from the plurality of orientations and an optimal position from the plurality of valid positions in order to optimize the packing efficiency function.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for fitting 2-dimensional (2D) part drawings in 2D sheet drawings, in accordance with some embodiments of the present disclosure.

FIG. 2 illustrates a functional block diagram of various modules within a memory of a computing device configured to fit 2D part drawings in 2D sheet drawings, in accordance with some embodiments.

FIG. 3 illustrates a flow diagram of an exemplary process for fitting 2D part drawings in 2D sheet drawings, in accordance with some embodiments of the present disclosure.

FIGS. 4A-4H illustrate determination of optimal orientation and optimal position of an exemplary part drawing, in accordance with some embodiments of the present disclosure.

FIGS. 5A and 5B illustrate fitting of exemplary part drawings on a 2D sheet, in accordance with some embodiments of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

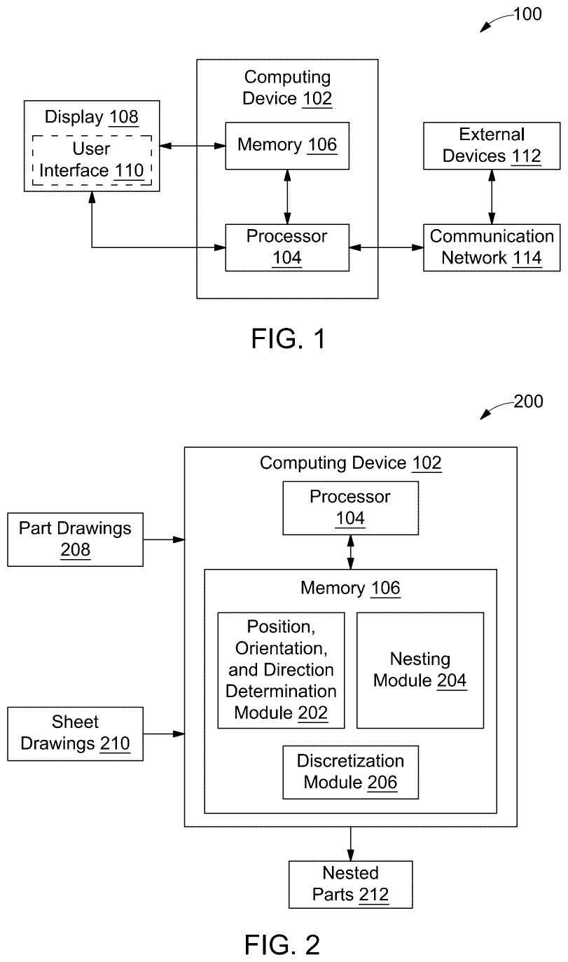

Referring now to FIG. 1, an exemplary system 100 for fitting 2-dimensional (2D) part drawings in 2D sheet drawings is illustrated, in accordance with some embodiments of the present disclosure. The system 100 may include a computing device 102 (for example, server, desktop, laptop, notebook, netbook, tablet, smartphone, mobile phone, or any other computing device), in accordance with some embodiments of the present disclosure. The computing device 102 may fit the 2D part drawings in the 2D sheet drawings. In other words, the present disclosure is related to techniques for packing 2D small shapes called parts in larger 2D shapes called sheets.

As will be described in greater detail in conjunction with FIGS. 2-5A-B, the computing device 102 may receive a first part drawing corresponding to a first 2D part and a sheet drawing corresponding to a 2D sheet. The 2D sheet may include a plurality of corners. The computing device 102 may further identify a plurality of valid positions for the first part drawing on the sheet drawing based on the plurality of corners and a plurality of predefined nesting directions. At each of the plurality of valid positions, the computing device 102 may further evaluate each of a plurality of orientations of the first part drawing on the sheet drawing based on predefined selection criteria. The computing device 102 may further determine an optimal orientation from the plurality of orientations and an optimal position from the plurality of valid positions based on the evaluation in order to optimize the packing efficiency function.

In some embodiments, the computing device 102 may include one or more processors 104 and a memory 106. Further, the memory 106 may store instructions that, when executed by the one or more processors 104, cause the one or more processors 104 to fit 2D part drawings in 2D sheet drawings, in accordance with aspects of the present disclosure. The memory 106 may also store various data (for example, a first part drawing, a sheet drawing, a 2D sheet, positions of the sheet drawings, an optimal orientation of the first part drawing, an optimal position of the first part drawing and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user via a user interface (UI) 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram of various modules within the memory 106 of the computing device 102 configured to fit 2D part drawings in 2D sheet drawings is illustrated, in accordance with some embodiments of the present disclosure. FIG. 2 is explained in conjunction with FIG. 1. The computing device 102 may include, within the memory 106, a Position, Orientation, and Direction Determination (PODD) module 202, a nesting module 204, and a discretization module 206.

The discretization module 206 may receive a part drawing 208 and a sheet drawing 210 corresponding to a 2D sheet. The part drawing 208 and the sheet drawing 210 may be provided by a user through a Graphical User Interface (GUI) (such as the UI 110). The part drawing 208 may correspond to a 2D part. The 2D part may be rectangular or non-rectangular. The 2D sheet may also be rectangular or non-rectangular. It should be noted that the 2D sheet may include a plurality of corners. The plurality of corners may be predefined by the user at a time of inputting the sheet drawing 210. Alternatively, the discretization module 206 may automatically identify the plurality of corners through a corner detection algorithm. The part drawing 208 and the sheet drawing 210 may be received as image files.

In an embodiment, the discretization module 206 may generate a pixel map corresponding to each of the part drawing 208 and the sheet drawing 210 through a discretization technique. Geometric data represented by the part drawing 208 and the sheet drawing 210 may be discretized in order to reduce computational time. The discretization technique may include converting the part drawing 208 and the sheet drawing 210 into a plurality of part drawing pixels and a plurality of sheet drawing pixels, respectively.

The PODD module 202 may identify a plurality of valid positions for the part drawing 208 on the sheet drawing 210 based on the plurality of corners and a plurality of predefined nesting directions. Each of the plurality of valid positions may be represented as position coordinates on the sheet drawing 210. It should be noted that each of the plurality of valid positions is a position on the sheet drawing 210 where the part drawing 208 may be non-overlapping with a previously fitted second part drawing on the sheet drawing 210. The second part drawing may be a copy of the part drawing 208. Alternatively, the second part drawing may be a copy of a different part drawing from the part drawing 208. By way of an example, the plurality of predefined nesting directions may include horizontal nesting, vertical nesting, diagonal nesting, and the like. In an exemplary scenario, a number of corners of the sheet drawing 210 is 4 and a number of the plurality of predefined nesting directions is 2. In such a scenario, number of valid positions for the part drawing 208 is 8 (i.e., 4 positions in each of the 2 nesting directions).

Further, at each of the plurality of valid positions, the PODD module 202 may evaluate each of a plurality of orientations of the part drawing 208 on the sheet drawing 210 based on predefined selection criteria. The plurality of orientations may correspond to a plurality of predefined permissible orientations provided by the user for the part drawing 208. The discretization module 206 may create a plurality of evaluation copies of the part drawing 208 and a plurality of evaluation copies of the sheet drawing 210 based on the plurality of valid positions and the plurality of orientations. It should be noted that each of the plurality of evaluation copies of the part drawing 208 and each of the plurality of evaluation copies of the sheet drawing 210 may be a discretized pixel map. In an embodiment, the plurality of evaluation copies of the part drawing 208 and the plurality of evaluation copies of the sheet drawing 210 may be generated through matrix operations (such as inverse and transpose) to make computations faster. For example, if there are 4 valid positions and 4 permissible orientations for the part drawing 208, the discretization module 206 may generate 16 evaluation copies of the sheet drawing 210 and 16 evaluation copies of the part drawing (4 evaluation copies for each of the 4 valid positions). Further, the PODD module 202 may place an evaluation copy of the part drawing 208 on an evaluation copy of the sheet drawing 210 at each of the plurality of valid positions at each of a plurality of orientations. Thus, 16 combinations of part drawing-sheet drawing evaluation copies may be obtained. Further, the PODD module 202 may evaluate each of the 16 combinations based on the predefined selection criteria. In an embodiment, the predefined selection criteria may be based on a center of gravity of the part drawing 208, height of the part drawing 208, or any combination thereof.

Further, the PODD module 202 may determine an optimal orientation from the plurality of orientations and an optimal position from the plurality of valid positions in order to optimize a packing efficiency function. To determine the optimal orientation and the optimal position of the part drawing 208, the PODD module 202 may calculate parameters (for example, center of gravity of the part drawing 208, height of the part drawing 208, or the like) for the predefined selection criteria corresponding to the part drawing 208. The packing efficiency function may be based on part geometry, part orientation, part position, and dimensions of the 2D sheet. In an embodiment, the packing efficiency function may be represented by equation (1).

$$Packing Efficiency = Max [ f ( Geometry , Orientation , Interval , Sheet Dimensions , Arrangement of Parts ) ] \qquad ( 1 )$$

Further, the nesting module 204 may fit the part drawing 208 on the sheet drawing 210 at the optimal position and the optimal orientation to provide a nested part drawing 212 on the sheet drawing 210.

Upon obtaining the nested part drawing 212, the discretization module 206 may receive a second part drawing (analogous to the part drawing 208). The second part drawing may be same as the part drawing 208 (i.e., a drawing of the same 2D part) or may be a drawing of a different 2D part. The computing device 102 may fit the second part drawing on the sheet drawing 210 in a similar manner to the fitting of the part drawing 208 explained above, to obtain a nested part corresponding to the second part drawing. This may be iterated for a plurality of part drawings until the PODD module 202 fails to identify a valid position on the sheet drawing 210 for a next part drawing.

In an embodiment, the user may input one or more part drawings (similar to the part drawing 208) corresponding to one or more distinct 2D parts to the computing device 102. The computing device 102 may then generate a nesting copy of one of the one or more part drawings. Further, the computing device 102 may fit the nesting copy on the sheet drawing 210 through the discretization module 206, the PODD module 202, and the nesting module 204. Then, the computing device 102 may generate a next nesting copy corresponding to one of the one or more part drawings and perform fitting of the next nesting copy on the sheet drawing 210. Similarly, a plurality of nesting copies of the one or more part drawings may be fitted on the sheet drawing 210 until the PODD module 202 fails to identify a valid position on the sheet drawing 210 for a next nesting copy.

In another embodiment, the discretization module 206 may receive the one or more part drawings. Further, the discretization module 206 may generate the plurality of nesting copies of each of the one or more part drawings. In such an embodiment, each of the plurality of nesting is a pixel map of one of the one or more part drawings. The plurality of nesting copies may be fitted on the sheet drawing 210 until the PODD module 202 fails to identify a valid position on the sheet drawing 210 for a next nesting copy.

It should be noted that all such aforementioned modules 202-206 may be represented as a single module or a combination of different modules. Further, as will be appreciated by those skilled in the art, each of the modules 202-206 may reside, in whole or in parts, on one device or multiple devices in communication with each other. In some embodiments, each of the modules 202-206 may be implemented as dedicated hardware circuit comprising custom application-specific integrated circuit (ASIC) or gate arrays, off-the-shelf semiconductors such as logic chips, transistors, or other discrete components. Each of the modules 202-206 may also be implemented in a programmable hardware device such as a field programmable gate array (FPGA), programmable array logic, programmable logic device, and so forth. Alternatively, each of the modules 202-206 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for fitting 2D part drawings in 2D sheet drawings. For example, the exemplary system 100 and the associated computing device 102 may fit 2D part drawings in 2D sheet drawings by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

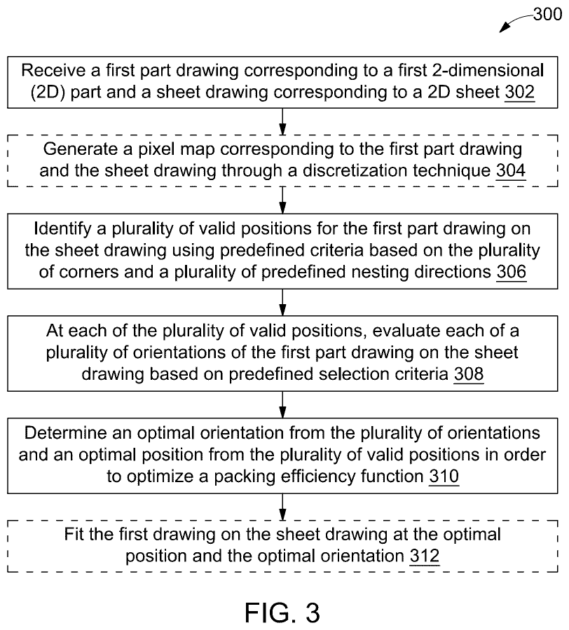

Referring now to FIG. 3, an exemplary process 300 for fitting a first part drawing in 2D sheet drawings is depicted via a flowchart, in accordance with some embodiments of the present disclosure. The process 300 may be implemented by the computing device 102 of the system 100. The process 300 may include receiving, by the discretization module 206, a first part drawing (for example, the part drawing 208) corresponding to a first 2D part and a sheet drawing (for example, the sheet drawing 210) corresponding to a 2D sheet, at step 302. The 2D sheet may include a plurality of corners.

Further, the process 300 may include generating, by the discretization module 206, a pixel map corresponding to the first part drawing, the plurality of subsequent part drawing and the sheet drawing through a discretization technique, at step 304. By way of an example, the discretization technique may be a pixel discretization technique.

Further, the process 300 may include identifying, by the PODD module 202, a plurality of valid positions for the first part drawing on the sheet drawing based on the plurality of corners and a plurality of predefined nesting directions, at step 306.

Further, at each of the plurality of valid positions, the process 300 may include evaluating, by the PODD module 202, each of a plurality of orientations of the first part drawing on the sheet drawing based on predefined selection criteria, at step 308. Each of the plurality of valid positions may be a position on the sheet drawing where the first part drawing is non-overlapping with a second part drawing. The second part drawing may be a part drawing that is previously fitted on the sheet drawing. The predefined selection criteria may be based on center of gravity of the part drawing, height of the part drawing, any combination thereof, or the like.

Further, the process 300 may include determining, by the PODD module 202, an optimal orientation from the plurality of orientations and an optimal position from the plurality of valid positions in order to optimize the packing efficiency function, at step 310. In an embodiment, parameters for the predefined selection criteria may be calculated by the PODD module 202 corresponding to the first part drawing. The packing efficiency function may be based on part geometry, part orientation, part position, and dimensions of the 2D sheet.

Further, the process 300 may include fitting, by the nesting module 204, the first part drawing on the sheet drawing based on the optimal position and the optimal orientation, at step 312. The nesting module 206 may place (i.e., nest) the first part drawing on the sheet drawing at the optimal position and at the optimal orientation. The steps 30

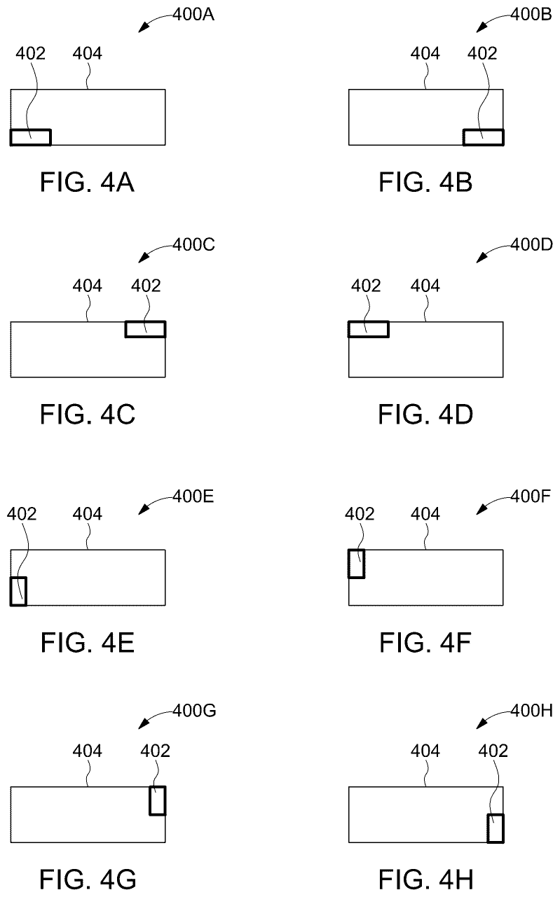

Referring now to FIGS. 4A-4H, determination of an optimal orientation and an optimal position of an exemplary part drawing 402 (analogous to the part drawing 208) on a sheet drawing 404 (analogous to the sheet drawing 210) is illustrated, in accordance with some embodiments of the present disclosure. In an embodiment, the part drawing 404 corresponds to a rectangular 2D part and the sheet drawing 404 corresponds to a rectangular 2D sheet. Thus, the sheet drawing 404 includes 4 corners. The user-defined plurality of nesting directions include horizontal nesting and vertical nesting. Additionally, the plurality of orientations permissible for the part drawing 402 may be a 0° angle and a 90° angle. Thus, the discretization module 206 may create 8 evaluation copies of the part drawing 402 and 8 evaluation copies of the sheet drawing 404 (2 evaluation copies for each of the 4 corners). It should be noted that each of the 8 evaluation copies of the part drawing 402 and each of the 8 evaluation copies of the sheet drawing 404 is a discretized pixel map. Further, the PODD module 202 may place an evaluation copy of the part drawing 402 on an evaluation copy of the sheet drawing 404 at each of the plurality of valid positions at each of a plurality of orientations.

In FIG. 4A, in a first combination 400A, an evaluation copy of the part drawing 402 is placed on an evaluation copy of the sheet drawing 404. The part drawing 402 is placed on a bottom left corner of the sheet drawing 404 at a 0° angle. The nesting direction in the first combination 400A is horizontal nesting.

In FIG. 4B, in a second combination 400B, an evaluation copy of the part drawing 402 is placed on an evaluation copy of the sheet drawing 404. The part drawing 402 is placed on a bottom right corner of the sheet drawing 404 at a 0° angle. The nesting direction in the second combination 400B is horizontal nesting.

In FIG. 4C, in a third combination 400C, an evaluation copy of the part drawing 402 is placed on an evaluation copy of the sheet drawing 404. The part drawing 402 is placed on a top right corner of the sheet drawing 404 at a 0° angle. The nesting direction in the third combination 400C is horizontal nesting.

In FIG. 4D, in a fourth combination 400D, an evaluation copy of the part drawing 402 is placed on an evaluation copy of the sheet drawing 404. The part drawing 402 is placed on a top left corner of the sheet drawing 404 at a 0° angle. The nesting direction in the fourth combination 400D is horizontal nesting.

In FIG. 4E, in a fifth combination 400E, an evaluation copy of the part drawing 402 is placed on an evaluation copy of the sheet drawing 404. The part drawing 402 is placed on a bottom left corner of the sheet drawing 404 at a 90° angle. The nesting direction in the fifth combination 400E is vertical nesting.

In FIG. 4F, in a sixth combination 400F, an evaluation copy of the part drawing 402 is placed on an evaluation copy of the sheet drawing 404. The part drawing 402 is placed on a top left corner of the sheet drawing 404 at a 90° angle. The nesting direction in the sixth combination 400F is vertical nesting.

In FIG. 4G, in a seventh combination 400G, an evaluation copy of the part drawing 402 is placed on an evaluation copy of the sheet drawing 404. The part drawing 402 is placed on a top right corner of the sheet drawing 404 at a 90° angle. The nesting direction in the seventh combination 400G is vertical nesting.

In FIG. 4H, in an eighth combination 400H, an evaluation copy of the part drawing 402 is placed on an evaluation copy of the sheet drawing 404. The part drawing 402 is placed on a bottom right corner of the sheet drawing 404 at a 90° angle. The nesting direction in the eighth combination 400G is vertical nesting.

Further, the PODD module 202 may evaluate each of the first combination 400A, the second combination 400B, the third combination 400C, the fourth combination 400D, the fifth combination 400E, the sixth combination 400F, the seventh combination 400G, and the eighth combination 400H, based on the predefined selection criteria. Further, the PODD module 202 may determine the optimal orientation and the optimal position of the part drawing 402 on the sheet drawing 404 based on the evaluation to optimize the packaging efficiency function.

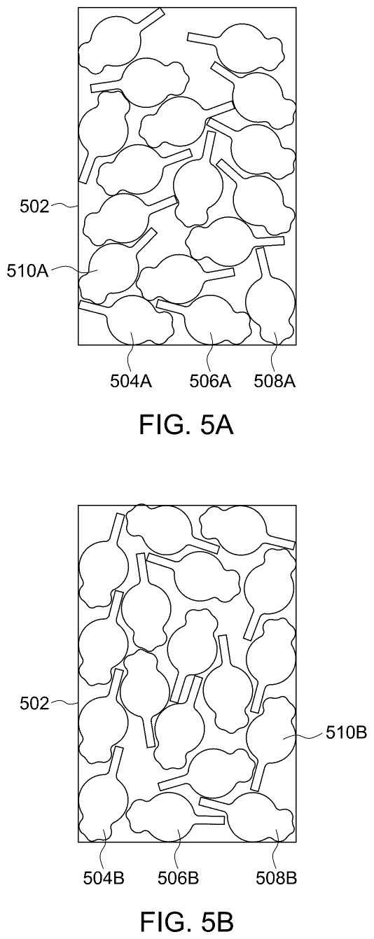

Referring now to FIGS. 5A and 5B, fitting of exemplary part drawings (analogous to the part drawing 208) on a sheet drawing 502 (analogous to the sheet drawing 210) is illustrated, in accordance with some embodiments of the present disclosure. In an embodiment, the sheet drawing 502 may correspond to a rectangular 2D sheet. The part drawings may correspond to a non-rectangular 2D part.

FIG. 5A illustrates a nesting layout generated through a conventional algorithm. The conventional algorithm determines the optimal position and the optimal orientation of a part drawing from one nesting corner and one nesting direction on the sheet drawing 502. Through the conventional algorithm, 17 copies of the part drawings are nested on the sheet drawing 502. By way of an example, the one nesting corner predefined by the user may be a bottom left corner of the sheet drawing 502. Additionally, the one nesting direction predefined by the user may be horizontal direction.

The conventional algorithm may first fit a part drawing 504A at the bottom left corner of the sheet drawing 502 at an optimal position and an optimal orientation corresponding to the part drawing 504A. Further, the conventional algorithm may fit a part drawing 506A horizontally adjacent to the part drawing 504A. Further, the conventional algorithm may fit a part drawing 508A horizontally adjacent to the part drawing 506A. The conventional algorithm may fail to identify a valid position horizontally adjacent to the part drawing 508A. Thus, the conventional algorithm may fit a part drawing 510A at a nearest valid position to the bottom left corner of the sheet drawing 502. The nearest valid position to the bottom left corner may be identified as a position right above the part drawing 504A.

FIG. 5B illustrates a nesting layout generated through the computing device 102. The computing device 102 determines the optimal position and the optimal orientation of a part drawing from a plurality of nesting corners and a plurality of nesting directions on the sheet drawing 502. Through the computing device 102, 18 copies of the part drawings are nested on the sheet drawing 502. By way of an example, the plurality of nesting corners of the sheet drawing 502 may include a bottom left corner, a bottom right corner, a top left corner, and a top right corner. Additionally, the plurality of nesting directions predefined by the user may be horizontal direction and vertical direction.

The nesting module 204 may first fit a part drawing 504B at the bottom left corner of the sheet drawing 502. The nesting module 204 may fit a part drawing 506B horizontally adjacent to the part drawing 504B. The nesting module 204 may fit a part drawing 508B horizontally adjacent to the part drawing 506B. The nesting module 204 may fail to identify a valid position horizontally adjacent to the part drawing 508B. Thus, the conventional algorithm may fit a part drawing 510B at an optimal position based on the plurality of corners and the plurality of nesting directions. The optimal position may be identified as a position right above the part drawing 508B.

Overall nesting direction of the 18 part drawings on the sheet drawing 502 by the computing device 102 is an inward spiral covering each of the plurality of corners and periphery first and then converging towards a center of the sheet drawing 502. It should be noted that the overall nesting direction may be definite in some embodiments and may be irregular or indefinite in some other embodiments. In the embodiment shown through FIGS. 5A and 5B, it may be inferred that through the use of the plurality of corners and the plurality of nesting directions, the process executed by the computing device 102 may outperform the conventional algorithms.

It should be noted that explanation for fitting of the parts 504B, 506B, 508B, and 510B is an exemplary scenario and a simplified explanation. Since the computing device 102 may determine an optimal position and an optimal position of a part drawing from the plurality of corners and the plurality of nesting directions, the fitting of the parts 504B, 506B, 508B, and 510B may not be carried out in the simplified sequential order as explained above. In some embodiments, other parts may be fitted near another of the plurality of corners before one of the parts 504B, 506B, 508B, and 510B are fitted on the sheet drawing 502.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

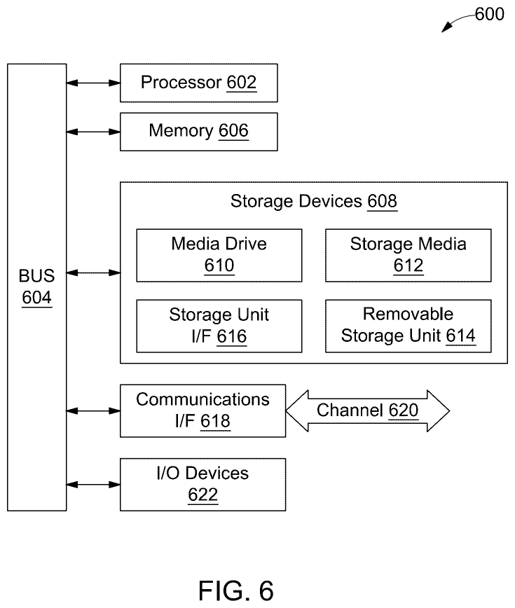

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Various embodiments provide method and system for simultaneously testing multiple Device Under Test (DUT) blocks. The disclosed method and system may receive a first part drawing corresponding to a first 2D part and a sheet drawing corresponding to a 2D sheet. Further, the disclosed method and system may evaluate each of a plurality of orientations of the first part drawing at each of a plurality of positions on the sheet drawing based on the predefined selection criteria. Moreover, the disclosed method and system may determine an optimal orientation of the first part drawing from the plurality of orientations at an optimal position of the first part drawing from the plurality of positions in order to optimize a packing efficiency function.

Thus, the disclosed method and system try to overcome the technical problem of fitting 2D part drawings in 2D sheet drawings. The method and system place as many parts as possible on a 2D sheet with minimum space left as waste. Further, the approach generates an optimal orientation from the plurality of orientations at an optimal position for the optimal orientation of a 2D part drawing. Further, the part drawings are not lost, and the overall computational time is reduced. Further, the nesting technique is found useful in improving the packing efficiency.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for fitting 2D part drawings in 2D sheet drawings. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for fitting 2-dimensional (2D) part drawings in 2D sheet drawings, the method comprising:
receiving, by a computing device, a first part drawing corresponding to a first 2D part and a sheet drawing corresponding to a 2D sheet, wherein the 2D sheet comprises a plurality of corners;
identifying, by the computing device, a plurality of valid positions for the first part drawing on the sheet drawing based on the plurality of corners and a plurality of predefined nesting directions;
at each of the plurality of valid positions, evaluating, by the computing device, each of a plurality of orientations of the first part drawing on the sheet drawing based on predefined selection criteria; and
determining, by the computing device, an optimal orientation from the plurality of orientations and an optimal position from the plurality of valid positions in order to optimize a packing efficiency function.

2. The method of claim 1, further comprising fitting, by the computing device, the first part drawing on the sheet drawing at the optimal position and the optimal orientation.

3. The method of claim 1, wherein each of the plurality of valid positions is a position on the sheet drawing where the first part drawing is non-overlapping with a second part drawing, wherein the second part drawing is previously fitted on the sheet drawing.

4. The method of claim 1, further comprising generating, by the computing device, a pixel map corresponding to the first part drawing and the sheet drawing through a discretization technique.

5. The method of claim 1, wherein determining the optimal orientation and the optimal position comprises calculating, by the computing device, parameters for the predefined selection criteria corresponding to the first part drawing.

6. The method of claim 1, wherein the packing efficiency function is based on part geometry, part orientation, part position, and dimensions of the 2D sheet.

7. A system for fitting 2-dimensional (2D) part drawings in 2D sheet drawings, the system comprising:
a processor; and
a memory communicatively coupled to the processor, wherein the memory stores processor instructions, which when executed by the processor, cause the processor to:
receive a first part drawing corresponding to a first 2D part and a sheet drawing corresponding to a 2D sheet, wherein the 2D sheet comprises a plurality of corners;
identify a plurality of valid positions for the first part drawing on the sheet drawing based on the plurality of corners and a plurality of predefined nesting directions;
at each of the plurality of valid positions, evaluate each of a plurality of orientations of the first part drawing on the sheet drawing based on predefined selection criteria; and
determine an optimal orientation from the plurality of orientations and an optimal position from the plurality of valid positions in order to optimize a packing efficiency function.

8. The system of claim 7, wherein the processor instructions, when executed by the processor, further cause the processor to fit the first part drawing on the sheet drawing at the optimal position and the optimal orientation.

9. The system of claim 7, wherein each of the plurality of valid positions is a position on the sheet drawing where the first part drawing is non-overlapping with a second part drawing, wherein the second part drawing is previously fitted on the sheet drawing.

10. The system of claim 7, wherein the processor instructions, when executed by the processor, further cause the processor to generate a pixel map corresponding to the first part drawing and the sheet drawing through a discretization technique.

11. The system of claim 7, wherein to determine the optimal orientation and the optimal position, the processor instructions, when executed by the processor, cause the processor to calculate parameters for the predefined selection criteria corresponding to the first part drawing.

12. The system of claim 7, wherein the packing efficiency function is based on part geometry, part orientation, part position, and dimensions of the 2D sheet.

13. A non-transitory computer-readable medium storing computer-executable instructions for fitting 2-dimensional (2D) part drawings in 2D sheet drawings, the computer-executable instructions configured for:
receiving a first part drawing corresponding to a first 2D part and a sheet drawing corresponding to a 2D sheet, wherein the 2D sheet comprises a plurality of corners;
identifying a plurality of valid positions for the first part drawing on the sheet drawing based on the plurality of corners and a plurality of predefined nesting directions;
at each of the plurality of valid positions, evaluating each of a plurality of orientations of the first part drawing on the sheet drawing based on predefined selection criteria; and
determining an optimal orientation from the plurality of orientations and an optimal position from the plurality of valid positions in order to optimize a packing efficiency function.

14. The non-transitory computer-readable medium of claim 13, wherein the computer-executable instructions are further configured for fitting the first part drawing on the sheet drawing at the optimal position and the optimal orientation.

15. The non-transitory computer-readable medium of claim 13, wherein each of the plurality of valid positions is a position on the sheet drawing where the first part drawing is non-overlapping with a second part drawing, wherein the second part drawing is previously fitted on the sheet drawing.

16. The non-transitory computer-readable medium of claim 13, wherein the computer-executable instructions are further configured for generating a pixel map corresponding to the first part drawing and the sheet drawing through a discretization technique.

17. The non-transitory computer-readable medium of claim 13, wherein for determining the optimal orientation and the optimal position, the computer-executable instructions are configured for calculating parameters for the predefined selection criteria corresponding to the first part drawing.

18. The non-transitory computer-readable medium of claim 13, wherein the packing efficiency function is based on part geometry, part orientation, part position, and dimensions of the 2D sheet.
